(19) United States
(12) Patent Application Publication
(10) Pub. No.: US 2021/0213683 A1
(43) Pub. Date: Jul. 15, 2021

(54) VALVE ASSEMBLY HAVING AN ISOLATION PLATE

(71) Applicant: HEWLETT-PACKARD DEVELOPMENT COMPANY, L.P., Spring, TX (US)

(72) Inventors: Nicholas WANG, Vancouver, WA (US); Luke P. SOSNOWSKI, Vancouver, WA (US)

(73) Assignee: HEWLETT-PACKARD DEVELOPMENT COMPANY, L.P., Spring, TX (US)

(21) Appl. No.: 16/076,039

(22) PCT Filed: Jul. 21, 2017
(86) PCT No.: PCT/US2017/043330

§ 371 Date: Aug. 7, 2018

(51) Int. Cl. B29C 64/321; F16K 11/074; F16K 31/04; F16K 37/00; B33Y 40/00; B22F 12/50

(52) U.S. Cl. CPC B29C 64/321; F16K 11/074; B22F 12/50; F16K 37/0041; B33Y 40/00; F16K 31/043

(57) ABSTRACT

According to examples, a valve assembly may include a port structure having a plurality of valve ports that each has an input opening. The valve assembly may also include an isolation plate movably mounted to the port structure, the isolation plate having a plurality of openings and an isolation opening. The isolation plate may be movable between a first position in which the plurality of openings is aligned with the input openings of the plurality of valve ports and a second position in which none of the plurality of openings is aligned with an input opening of the plurality of valve ports.

### BACKGROUND

In three-dimensional (3D) printing, an additive printing process may be used to make three-dimensional solid parts from a digital model. 3D printing may be used in rapid product prototyping, mold generation, mold master generation, and short-run manufacturing. Some 3D printing techniques are considered additive processes because they involve the application of successive layers of material to an existing surface (or previous layer). This is unlike traditional machining processes, which often rely upon the removal of material to create the final part. 3D printing may use curing or fusing of the building material, which for some materials may be accomplished using heat-assisted extrusion, melting, or sintering, and for other materials may be performed through curing of polymer-based build materials.

### BRIEF DESCRIPTION OF THE DRAWINGS

Features of the present disclosure are illustrated by way of example and are not limited in the following figure(s), in which like numerals indicate like elements, in which:

FIG. 1A illustrates a top perspective view of an example valve assembly;

FIG. 1B illustrates a bottom perspective view of an example port structure of the example valve assembly shown in FIG. 1A;

FIG. 1C illustrates a cross-sectional side view of the example port structure shown in FIGS. 1A and 1B;

FIGS. 2A-2H, respectively, illustrate various different settings of an example isolation plate of the valve assembly depicted in FIGS. 1A-1C,

FIG. 3 shows a top perspective view of another example valve assembly;

FIG. 4 shows an example 3D printing system having an example clog detection and unclogging mechanism;

FIG. 5 shows a schematic diagram of a portion of an example 3D printing system;

FIG. 6 illustrates a block diagram of a simplified view of an example 3D printing system; and

FIG. 7 illustrates a flow diagram of an example process for selectively controlling a valve assembly.

### DETAILED DESCRIPTION

In powder-based three-dimensional (3D) printing systems, successive layers of a powder, or powder-type, build material may be formed, for example, on a build platform. Portions of each layer may be selectively solidified, with each portion representing a portion of a 3D object to be formed. In some examples, a build material may include a powdered build material that is composed of particles in the form of fine powder or granules. In addition or in other examples, the build material may include short fibers. In any regard, the powdered build material may include metal particles, plastic particles, polymer particles, or particles of other materials.

The 3D printing systems may include a build platform on which the 3D object is formed. Any incidental build material that is not used in forming the 3D object may be passed to a build material reservoir in which the incidental build material may be stored and/or from which the build material may be supplied for use on the build platform. The incidental build material may be transported through conduits (e.g., hoses) from the build platform to the build material reservoir. A conduit may refer to any transport path that may be used to transport a build material, or other type of material, from a first location to a second location.

In some cases, for example, due to agglomeration of build material particles, or due to the presence of foreign particles, some of the conduits for transporting the incidental build material may become clogged. In other cases, a large amount of build material particles (even if not agglomerated) may also cause clogging of a conduit. If clogged, the conduits may not be able to properly transport incidental build material away from the build platform.

Disclosed herein is a valve assembly that may include a port structure having a plurality of valve ports to which the conduits for transporting the incidental build material may be engaged. The valve assembly may also include an isolation plate having a plurality of openings and an isolation opening. As discussed herein, when a particular conduit is determined as being clogged, the isolation plate may be moved such that the isolation opening is aligned with the valve port with which the clogged conduit is engaged while the isolation plate blocks the other valve ports. In one regard, the flow rate of airflow supplied through the port structure may be focused on the particular valve port, which may increase the pressure within the particular conduit and may unclog the conduit. The isolation plate may thus be moved to different positions to clear clogged conduits.

Before continuing, it is noted that as used herein, the terms “includes” and “including” mean, but is not limited to, “includes” or “including” and “includes at least” or “including at least.” The term “based on” means “based on” and “based at least in part on.”

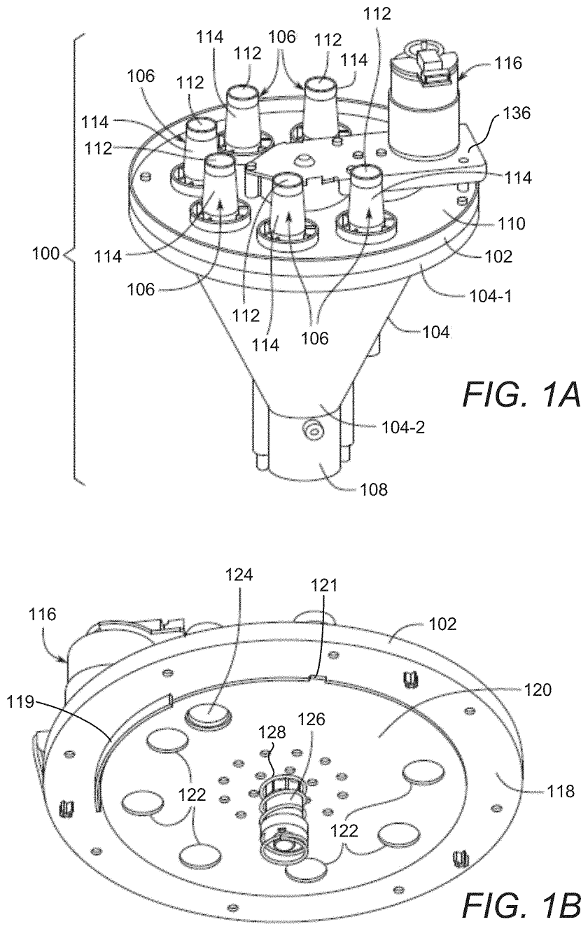

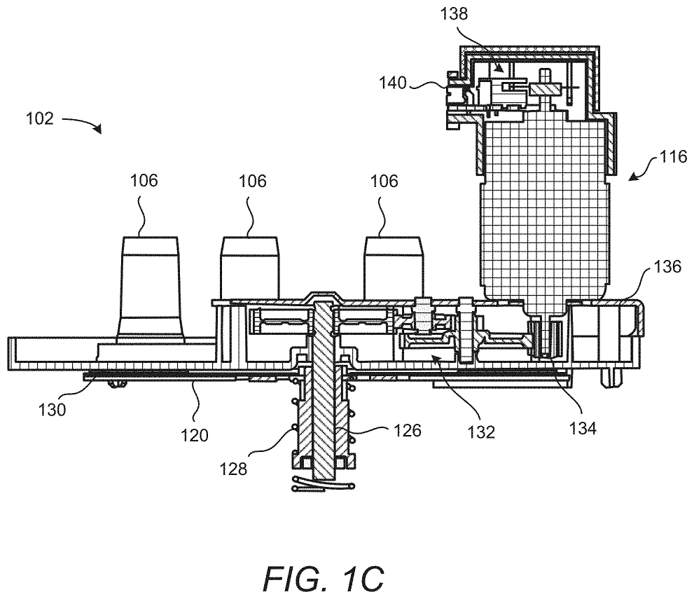

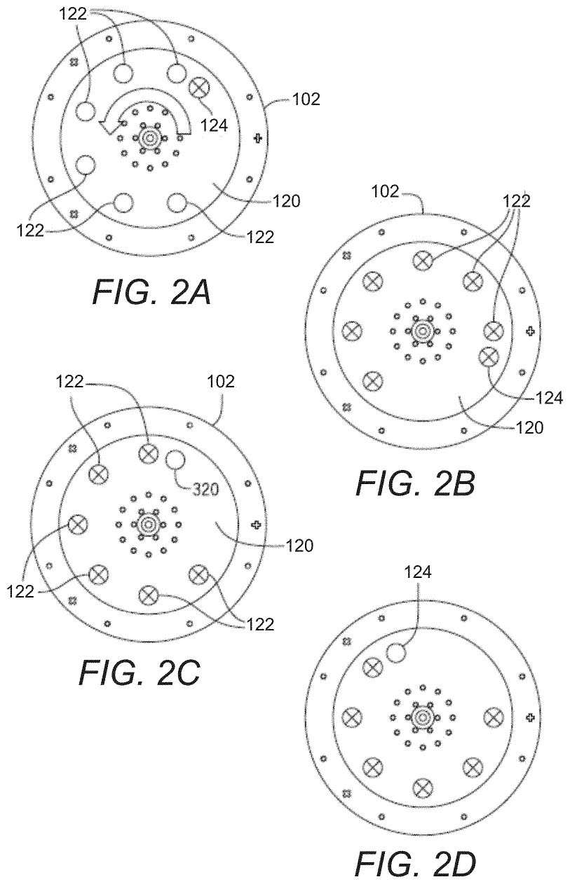

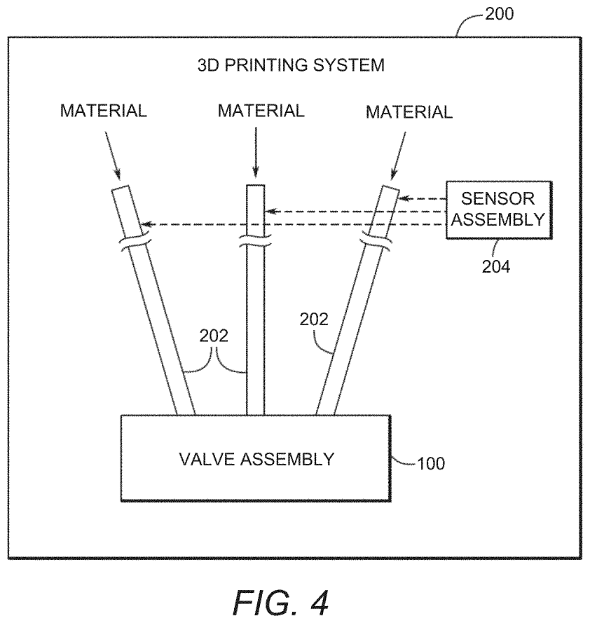

FIG. 1A illustrates a top perspective view of an example valve assembly 100, FIG. 1B illustrates a bottom perspective view of an example port structure 102 of the example valve assembly 100, and FIG. 10 illustrates a cross-sectional side view of the example port structure 102. As shown in FIG. 1A, the valve assembly 100 may include a funnel 104 and the port structure 102. The port structure 102 may have a base member from which multiple valve ports 106 may extend. The valve ports 106 may be connected to a plurality of conduits, or equivalently, hoses, as discussed in greater detail herein with respect to FIGS. 4-6. The funnel 104 may direct build material received at the valve ports 106 through the conduits to an output port 108. The funnel 104 has a wide side 104-1 and a narrow side 104-2. The port structure 102 may be attached to the wide side 104-1 of the funnel 104 and the narrow side 104-1 may lead to the output port 108.

The base member of the port structure 102 may have an upper surface 110 and the valve ports 106 may extend above the upper surface 110. Each of the valve ports 106 may have an input opening 112 defined by tubular inserts 114. A plurality of the conduits, which are shown in FIG. 4, and which may be in the form of hoses, for example, may fit over the tubular inserts 114 to engage with the valve ports 106. In addition, build material flowing in each conduit may enter the respective valve port 106 through the corresponding input opening 112.

The port structure 102 may also include a motor 116 that may move a valve control member to control the open/close status of each of the valve ports 106. In FIG. 1B, the valve control member that may be used to control the open/close status of the valve ports 106 is depicted as being in the form of a rotatable isolation plate 120. The isolation plate 120 may generally be circular in shape, and may be located below a lower surface 118 of the base member of the port structure 102. The isolation plate 120 may have various openings 122 and an isolation opening 124. The openings 122 may be located in the isolation plate 120 such that in one position of the isolation plate 120, the openings 122 are aligned with a respective input opening 112 of the valve ports 106 and in another position, none of the openings 122 are aligned with any of the input openings 112.

Additionally, the isolation opening 124 may be located in the isolation plate 120 such that the isolation opening 124 may be aligned with an input opening 112 of a valve port 106 while none of the openings 122 are aligned with the input openings 112 of the other valve ports 106. In this regard, and as shown in FIG. 1B, the isolation opening 124 may be located in closer proximity to one of the openings 122 than to the other openings 122, while the openings 122 are spaced from a neighboring opening by a set distance. In any regard, the openings 122, when aligned with the valve ports 106, may set all of the valve ports 106 to the open position. The isolation opening 124 may be aligned with one of the valve ports 106 to selectively open the valve port 106 while the isolation plate 120 maintains the remaining valve ports 106 in the closed position.

The isolation plate 120 may be attached to a rotatable rod 126 such that the isolation plate 120 rotates with the rotatable rod 126. A spring 128 may be attached to the rotatable rod 126 to bias the isolation plate 120 toward the bottom surface 118 of the port structure 102. In addition, as shown in FIG. 10, a seal 130 may be provided between the isolation plate 120 and the bottom surface 118 to reduce or eliminate the flow of air out of the interface between the isolation plate 120 and the bottom surface 118. The seal 130 may include apertures that are aligned with and sized similarly to the openings 122 and the isolation opening. The seal 130 may be attached to one of the bottom surface 118 of the base member and a top surface of the isolation plate 120 may be in slidable contact with the other of the base member and the isolation plate 120.

As also shown in FIG. 10, the motor 116 may drive the rotatable rod 126 to rotate the isolation plate 120 into multiple positions. Particularly, the rotatable rod 126 may be attached to a drive train 132 that includes a number of gears, which the motor 116 may drive through rotation of a drive member 134. The drive train 132 may be housed in a drive train housing 136. An encoder 138 may be provided to detect the rotational movement of the drive member 134 from which a control circuit 140 may determine the rotational position of the drive member 134. The rotational position of the drive member 134 may be used to identify a current setting of the valve assembly 100, e.g., that all of the openings 122 are aligned with respective input openings 112 of the valve ports 106. In addition, the motor 116 may be activated to rotate the isolation plate 120 to a certain position such that the isolation opening 124 is aligned with the input opening 112 of a particular valve port 106 while the input openings 112 of the other valve ports 106 are closed by the isolation plate 120. In this regard, the motor 116 may be controlled to move the isolation plate 120 into a number of positions and the rotational position of the isolation plate 120 may be determined from a detected rotational position of the drive member 134. With reference back to FIG. 1B, a rib 119 may extend below the lower surface 118 and a tab 121 may be provided on the isolation plate 120. The location of the tab 121 with respect to the rib 119 may be used to establish a known starting point for the encoder 138.

In other examples, instead of using a rotatable isolation plate that is circular in shape, the isolation plate 120 may have a different shape. In addition or in other examples, the isolation plate 120 may be translated in a linear direction rather than being rotated.

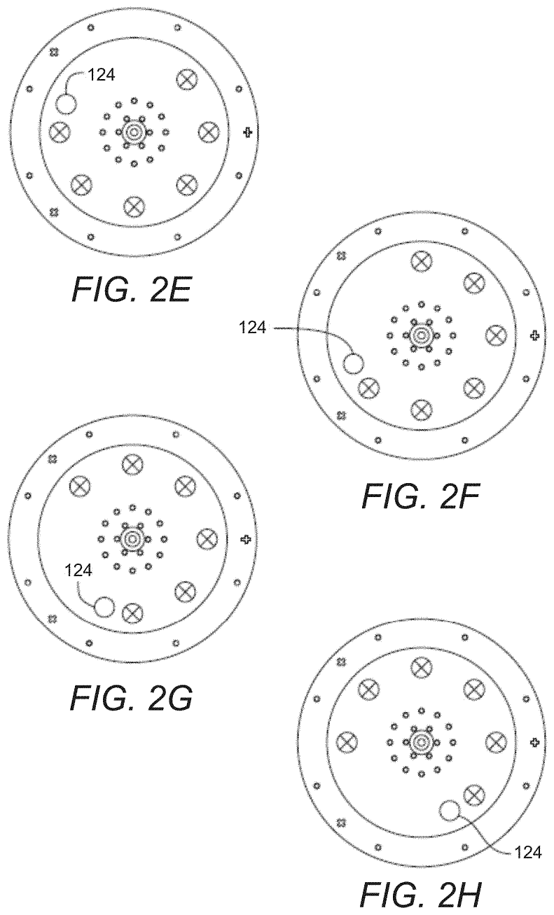

FIGS. 2A-2H, respectively, illustrate various different settings of the example isolation plate 120. In a fully open setting shown in FIG. 2A, the openings 122 of the isolation plate 120 are aligned with the input openings 112 of the respective valve ports 106, and thus, all of the valve ports 106 are fully open. In addition, the isolation opening 124 is depicted in FIG. 2A with an “X” to denote that the isolation opening 124 may not be aligned with any of the input openings 112. The motor 116 may rotate the isolation plate 120 in a counterclockwise direction, in a clockwise direction, or in either the counterclockwise direction or the clockwise direction.

In FIG. 2B, rotation of the isolation plate 120 may cause the isolation plate 120 to be moved to a closed setting, where none of the openings 122 and or the isolation opening 124 are aligned with the valve ports 106, and therefore, all of the valve ports 106 are closed. In other examples, the isolation plate 120 may be moved such that the isolation plate 120 partially opens the valve ports 106.

FIGS. 2C-2H illustrate successive incremental settings of the isolation plate 120, where the isolation plate 120 is incrementally moved to cause the isolation opening 124 to be successively aligned with the input openings 112 of different ones of the valve ports 106. FIG. 2C shows the isolation opening 124 aligned with a first valve port 106, such that a first valve port 106 is open while the remaining valve ports 106 are closed. FIG. 2D shows the isolation opening 124 aligned with a second valve port 106, FIG. 2E shows the isolation opening 124 aligned with a third valve port 106, FIG. 2F shows the isolation opening 124 aligned with a fourth valve port, FIG. 2G illustrates the isolation opening 124 aligned with a fifth valve port 106, and FIG. 2H illustrates the isolation opening 124 aligned with a sixth valve port 106. Each of FIGS. 2D-2H shows respective different ones of the valve ports 106 being open while remaining valve ports 106 are closed.

In other examples, while the isolation plate 120 is actuated to set one of the valve ports 106 to a fully open position, the isolation plate 120 may set the remaining openings 122 to be partially open. In further examples, more than one valve port 106 may be set to an open position, while the remaining valve ports 106 are set in a restricted flow position.

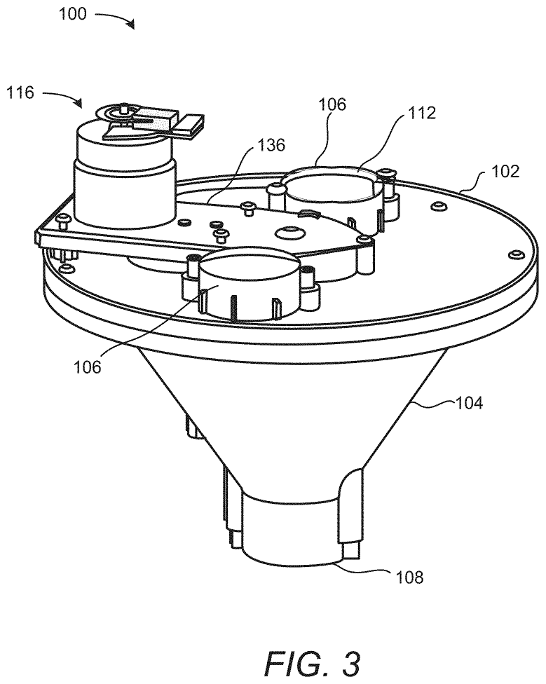

Although the port structure 102 has been depicted as including six valve ports 106, it should be understood that the port structure 102 may have any number of valve ports 106. For instance, in FIG. 3, there is shown a valve assembly 100 having a port structure 102 that includes a different configuration of valve ports 106 than the valve assembly 100 depicted in FIG. 1A. That is, the port structure 102 depicted in FIG. 3 may include two valve ports 106 having input openings 112, in which the valve ports 106 and the input openings 112 are relatively larger than the valve ports 106 and input openings 112 of the port structure 102 depicted in FIG. 1A. In this regard, air and materials may flow at a greater flow rate through the input openings 112 of the valve ports 106 in the port structure 102 depicted in FIG. 3.

An isolation plate 120 may also be positioned underneath the port structure 102 in similar manners to those depicted in FIGS. 1B and 10. However, the isolation plate 120 may include two openings 122 that may simultaneously be aligned with the valve ports 106 and an isolation opening 124 that may be aligned with one of the valve ports 106 while the other valve port 106 remains closed by the isolation plate 120. The isolation plate 120 may be moved into multiple positions in similar manners to those discussed above with respect to FIGS. 2A-2H to open one, both, or none of the valve ports 106.

By way of particular example, the valve assembly 100 with the port structure 102 depicted in FIG. 3 may be connected to conduits that are positioned to collect incidental powder from a build bucket of a 3D printing system. That is, the conduits to which the valve ports 106 may be attached may terminate at a build bucket within which 3D objects are formed and the incidental powder, e.g., the powder that is not used in the build bucket to form the 3D objects, may be removed from the build bucket via the conduits. In this example, the valve assemblies 100 depicted in FIGS. 1A and 3 may both be implemented in the same 3D printing system to collect incidental powder from multiple locations of the 3D printing system. In addition, the valve ports 106 of one of the valve assemblies 100 may be closed while the valve ports 106 of the other one of the valve assemblies 100 are opened to increase airflow through the open valve ports 106.

According to examples, the isolation plate 120 may be moved to one of the incremental settings shown in FIGS. 2C-2H in response to a respective conduit being detected as clogged. That is, and in accordance with some implementations of the present disclosure, the valve assembly 100 may be implemented as part of an example clog detection and unclogging mechanism in a 3D printing system 200 as shown in FIG. 4. Generally speaking, the clog detection and unclogging mechanism may be provided in a 3D printing system 200 to detect a clogged condition of any of multiple conduits 202, and to take action in response to the clogged condition being detected. As shown, the clog detection and unclogging mechanism may include the valve assembly 100 shown in FIGS. 1A-1C, 2A-2H, and 3 to which the multiple conduits 202 may be attached and a sensor assembly 204 to detect a clogged condition of a given conduit 202.

In some examples, the sensor assembly 204 includes pressure sensors to sense pressures at points along the respective conduits 202. For example, each pressure sensor may be placed near a location where a build material enters into the respective conduit 202. In other examples, the pressure sensor may be placed at another location along the respective conduit 202. A measured pressure falling outside a specified pressure range may be an indication that the respective conduit is clogged. For example, a measured pressure of 0 atmospheres (atm) may be an indication that no flow is occurring in the conduit 202. A measured pressure that is a negative pressure that is below a negative pressure threshold may also be an indication that no flow is occurring in the conduit 202. A measured pressure between 0 atm and the negative pressure threshold may be construed as an indication of a normal operation of the respective conduit (i.e., the respective conduit is not clogged). More generally, a measured pressure that is within a range between P1 and P2 may be an indication that the respective conduit 202 is functioning normally. However, a measured pressure that falls outside the range between P1 and P2 may be an indication that the respective conduit 202 may be clogged.

In other examples, instead of or in addition to using pressure sensors, the sensor assembly 204 may include another type of sensor, such as a flow rate sensor to measure a rate of flow of airflow containing the build material particles in the respective conduit 202. A measured flow rate that drops below a specified threshold may be an indication of a potential clogged condition of the respective conduit 202. However, a measured flow rate that is above the specified threshold may be an indication that the respective conduit 202 is operating normally.

The valve assembly 100 may selectively control flow of the build material through the conduits 202. As discussed above, the valve assembly 100 is controllable to set the valve ports 106 (FIG. 1A) of the valve assembly 100 in any one of various different settings. In a first setting, the valve assembly 100 allows build material flow through all of the conduits 202. In a second setting, the valve assembly 100 may allow build material flow through just one of the conduits 202 (or through a selected subset of the conduits 202), while flow through the remaining conduits 202 is restricted or blocked. The components of the valve assembly 100 may be actuated from the first setting to the second setting in response to a clogged condition of a conduit 202 (or multiple conduits 202) being detected. Actuating the components of the valve assembly 100 from the first setting to the second setting allows for an increased flow force (e.g., increased draw by a vacuum source or an airflow generator) to be applied to the clogged conduit(s) 202. Applying an increased flow force to the clogged conduit(s) 202 may aid in unclogging the clogged conduit(s) 202.

In the ensuing discussion, reference is made to detecting a clogged condition of a conduit 202 that transports a build material. In other examples, a conduit 202 may be used to transport another type of material, which may be in the form of solid particles or a fluid.

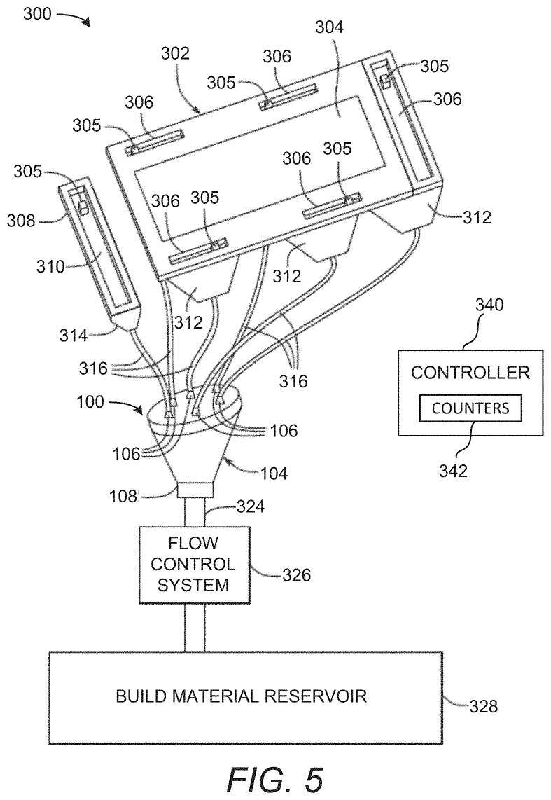

FIG. 5 is a schematic diagram of a portion of an example 3D printing system 300. As shown, the 3D printing system 300 may include a build platform 302 on which a 3D object may be formed by depositing successive layers of build material onto a build bed 304. The build platform 302 has a generally planar upper surface, on which the build bed 304 is provided. During formation of the 3D object, incidental build material (build material that is not used as part of the 3D printing process) may fall through openings 306 formed in the build platform 302.

Another incidental material receiving structure 308 may be provided on one side and slightly below the build platform 302, to receive any incidental build material that falls off the build platform 302. The incidental material receiving structure 308 may include an opening 310 through which incidental build material may be collected. The incidental build material may pass through respective plenums 312 and 314, which are connected to conduits 316.

Sensors 305 may be provided in or near the respective openings 306 and 310 to measure pressure or flow rate at the openings 306 and 310. The sensors 305 may be pressure sensors, flow rate sensors, or other types of sensors that may make measurements for determining whether or not a corresponding conduit 316 is clogged. The sensors 305 may be parts of the sensor assembly 204 shown in FIG. 4.

The conduits 316 may be used to transport the incidental build material from the respective plenums 312 and 314 to the valve assembly 100. The valve assembly 100 may have multiple valve ports 106 to which the conduits 316 are attached. Incidental build material may flow through the conduits 316 and the valve ports 106. As discussed in greater detail herein, the valve assembly 100 may selectively control whether the valve ports 106 are open or closed (or more generally, at a restricted flow position). A restricted flow position of a valve port 106 may refer to a position where the valve port 106 is closed (e.g., no fluid flow occurs through the valve port 106) or the valve port 106 is partially open (e.g., the valve port 106 is not fully open such that the flow through the valve port 106 is restricted as compared to the flow through the valve port 106 when in the fully open position).

In one setting, all of the valve ports 106 may be open. In another setting, all of the valve ports 106 may be closed (or all of the valve ports 106 may be set to a restricted flow position). The valve assembly 100 may also have other settings in which a first subset of the valve ports 106 are open while the remaining valve ports 106 are in a restricted flow position. For example, one valve port 106 may be set to the fully open position, while the remaining valve ports 106 are set to a restricted flow position.

The valve assembly 100 may also include an output port 108 that is connected to an output conduit 324. Assuming at least one valve port 106 is open, build material may flow through a respective conduit 316 (or multiple conduits 316) through the valve assembly 100 and the output port 108 to the output conduit 324.

A flow control system 326 may be provided to cause the build material to flow through the output conduit 324 and into a build material reservoir 328. In some examples, the flow control system 326 may include a vacuum source, which is to draw down pressure such that a flow is induced through the output conduit 324. In addition or in other examples, the flow control system 326 may include an airflow generator, such as a fan. In any regard, the build material reservoir 328 may be a bin in which incidental build material is collected and stored and/or a bin that supplies incidental build material to the build platform 302 for reuse in building 3D objects.

Although FIG. 5 shows the flow control system 326 positioned between the valve assembly 100 and the build material reservoir 328, the flow control system 326, may either be located upstream of the valve assembly 100 or downstream of the build material reservoir 328 in other examples. In such alternative arrangements, a filter and air-powder separator may be provided between the build material reservoir 328 and the flow control system 326 to separate air from the build material.

As also shown in FIG. 5, the 3D printing system 300 may include a controller 340 that may control the setting of the valve assembly 100. That is, the controller 340 may receive signals from the sensors 305 and may determine whether any of the conduits 316 are clogged from the received signals. In response to a determination that one of the conduits 316 is clogged, the controller 340 may cause the motor 116 to rotate and thus move the isolation plate 120 in the valve assembly 100 to isolate airflow through the valve assembly 100 to just the conduit 316 that has been identified as being clogged. By way of particular example in which a sensor 305 detects that the conduit 316 connected to the fourth valve port 106 is clogged, the controller 340 may control the motor 116 (FIGS. 1A-1C)) to actuate the isolation plate 120 to the incremental setting shown in FIG. 2F, in which the isolation opening 124 of the isolation plate 120 is aligned with the fourth valve port 106. By opening the fourth valve port 106 while closing the other remaining valve ports 106, the pressure on the airflow flowing through the conduit 316 connected to the fourth valve ports 106 may significantly be increased to this clear out the blockage in the conduit 316.

If multiple conduits 316 are clogged, the controller 340 may control the motor 116 to actuate the isolation plate 120 to successive incremental settings corresponding to the multiple clogged conduits 316. For example, if the multiple clogged conduits 316 correspond to the second and fifth valve ports 106, the isolation plate 120 may be actuated first to the incremental setting of FIG. 2D in an attempt to clear the clogged condition of the conduit 316 connected to the second valve port 106. Next, the isolation plate 120 may be actuated to the incremental setting of FIG. 2G in an attempt to clear the clogged condition of the conduit 316 connected to the fifth valve port 106.

By setting just a subset of the valve ports 106 to the fully open position, while the remaining valve port(s) 106 is (are) in a restricted flow position, an increased flow force (e.g., increased draw by the flow control system 326 of FIG. 5) may be applied to clogged conduit(s) 316. Applying an increased flow force to the clogged conduit(s) 316 may aid in unclogging the clogged conduit(s) 316.

In some examples, the controller 340 may maintain the isolation plate 120 at a specific incremental setting for a specified time duration (e.g., 5 minutes or another example time duration). This time duration is to provide an opportunity for the increased pressure draw of the open valve port 106 to clear the respective clogged conduit 316. Alternatively, the controller 340 may maintain the isolation plate 120 at the specific incremental setting until the corresponding pressure as detected by a sensor 305 provides a measurement indicating that the corresponding conduit 316 is no longer clogged.

In some examples, as shown in FIG. 5, the controller 340 may include a counter 342 of a number of times that unclogging of a particular conduit has been attempted. For example, there may be one counter per valve port 106, so that the controller 340 includes multiple counters 342. Each time the isolation plate 120 is set to an incremental setting corresponding to a particular valve port 106, the corresponding counter 342 is advanced (incremented or decremented). If the counter 342 reaches a specified threshold value, then that may be an indication that something is wrong with the 3D printing system 300, since the corresponding conduit 316 keeps clogging or the valve assembly 100 is unable to unclog the corresponding conduit 316 after the threshold number of attempts. The controller 340 may send an alert to a user or other entity (a machine or a program) in response to a counter 342 advancing to the specified threshold value.

More generally, a counter 342 may track a number of times a clogged condition is detected for a given conduit 316. The controller 340 may provide an alert in response to a count of the counter 342 advancing to a predefined threshold.

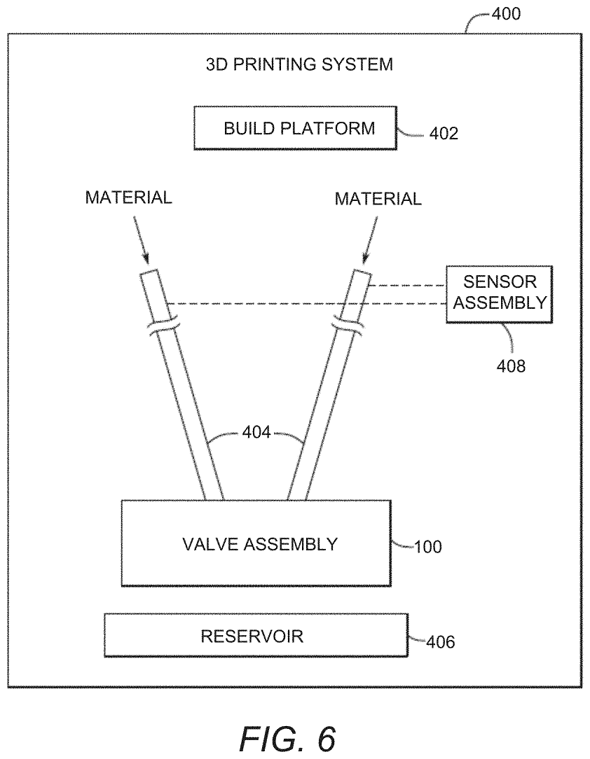

FIG. 6 is a block diagram of a simplified view of a 3D printing system 400 according to further examples. The 3D printing system 400 may include a build platform 402 to build a 3D object using a material. Multiple conduits 404 may receive incidental material from the build platform 402. The conduits 404 are used to transport the incidental material to a reservoir 406.

A sensor assembly 408 may measure pressures of the respective conduits 404. A valve assembly 100 is connected to the conduits 404 to selectively control flow of the material through the conduits 404. As discussed above, the valve assembly 100 is controllable to actuate from a first setting to a second setting responsive to the sensor assembly 408 detecting a pressure of a first conduit of the multiple conduits 404 being outside a predefined range.

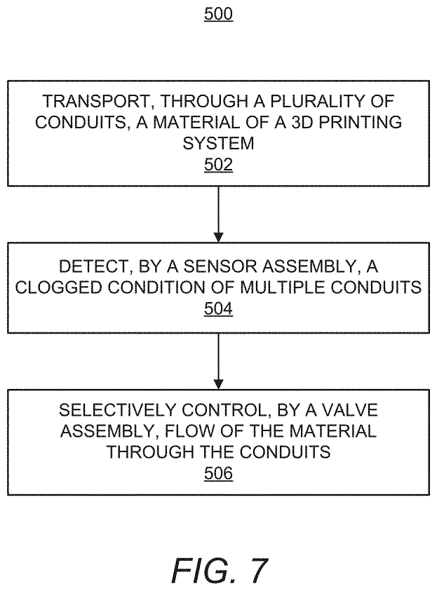

FIG. 7 is a flow diagram of an example process 500 for selectively controlling a valve assembly 100. The process 500 may include transporting (at 502), through a plurality of conduits, a material of a 3D printing system between locations in the 3D printing system. The process 500 may also include detecting (at 504), by a sensor assembly, a clogged condition of multiple conduits. The process 500 may further include selectively controlling (at 506), by a valve assembly, flow of the material through the conduits, where the valve assembly is controllable to actuate from a first setting to a second setting to unclog a first conduit, and from the second setting to a third setting to unclog a second conduit.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A valve assembly comprising:
a port structure having a plurality of valve ports, each of the valve ports having an input opening; and
an isolation plate movably mounted to the port structure, the isolation plate having a plurality of openings and an isolation opening, the isolation plate being movable between a first position in which the plurality of openings is aligned with the input openings of the plurality of valve ports and a second position in which none of the plurality of openings is aligned with an input opening of the plurality of valve ports.

2. The valve assembly according to claim 1, further comprising a motor, wherein the motor is further to move the isolation plate between the first position, the second position, and a third position in which the isolation opening is aligned with an input opening of the plurality of valve ports while none of the plurality of openings is aligned with an input opening of the plurality of valve ports.

3. The valve assembly according to claim 2, further comprising:
an encoder to detect rotational movement of a drive member of the motor; and
a controller to determine a position of the drive member based upon the detected rotational movement of the drive member, wherein the position of the drive member is used to determine a position of the isolation plate.

4. The valve assembly according to claim 1, wherein each of the valve ports includes a tubular insert defining a respective input opening, wherein each of the tubular inserts is to engage with a conduit.

5. The valve assembly according to claim 1, further comprising:
a seal between the isolation plate and a bottom surface of the port structure; and
a spring to press the isolation plate into contact with the seal.

6. The valve assembly according to claim 1, further comprising:
a rod attached to the isolation plate and rotatably attached to the port structure, wherein rotation of the rod with respect to the port structure causes the isolation plate to rotate with respect to the port structure.

7. The valve assembly according to claim 6, further comprising
a motor;
a first gear attached to the rod;
a second gear attached to a drive member of the motor; and
a drive train to translate rotational movement of the drive member into rotational movement of the isolation plate through rotation of the first gear and the second gear.

8. The valve assembly according to claim 1, further comprising:
a funnel having a wide side and a narrow side, wherein the port structure is attached to the wide side of the funnel.

9. A port structure comprising:
a base member;
a plurality of valve ports extending from a first surface of the base member, each of the valve ports having tubular insert defining an input opening;
a rod rotatably mounted to the base member; and
an isolation plate attached to the rod, the isolation plate having a plurality of openings and an isolation opening, wherein each of the plurality of openings is spaced from a neighboring opening by a set distance and wherein a distance between the isolation opening to one of the plurality of openings differs from distances between the isolation opening and the other plurality of openings.

10. The port structure according to claim 9, further comprising:
a motor having a drive member;
a drive train to translate rotation of the drive member into rotation of the rod; and
a drive train housing that houses the drive train.

11. The port structure according to claim 10, wherein the motor is to move the isolation plate between a first position in which each of the plurality of openings is aligned with a respective input opening, a second position in which none of the plurality of openings is aligned with an input opening, and a third position in which the isolation opening is aligned with one of the input openings while none of the plurality of openings is aligned with an input opening.

12. The port structure according to claim 9, further comprising:
a seal between the isolation plate and a bottom surface of the port structure; and
a spring to press the isolation plate into contact with the seal.

13. A valve assembly comprising:
a funnel having a wide side and a narrow side;
a port structure attached to the wide side of the funnel, the port structure having:
a base member;
a plurality of valve ports extending from the base member, each of the valve ports having a tubular insert defining an input opening, wherein respective conduits are to be engage the tubular inserts;
an isolation plate movably mounted to the base member, the isolation plate having a plurality of openings and an isolation opening; and
a motor to move the isolation plate between a first position in which the plurality of openings is aligned with the input openings of the plurality of valve ports, a second position in which none of the plurality of openings is aligned with an input opening of the plurality of valve ports, and a third position in which the isolation opening is aligned with one of the input openings while none of the plurality of openings is aligned with an input opening.

14. The valve assembly according to claim 13, further comprising:
a rod attached to the isolation plate and rotatably attached to the base member, wherein rotation of the motor causes rotation of the rod and the isolation plate.

15. The valve assembly according to claim 13, further comprising:
a seal between the isolation plate and a bottom surface of the port structure; and
a spring to press the isolation plate into contact with the seal.
